(19) United States
(12) Patent Application Publication
(10) Pub. No.: US 2011/0174118 A1
(43) Pub. Date: Jul. 21, 2011

(54) GEAR UNIT AND MOLDING METHOD OF THE SAME AND APPLIED RATCHET WHEEL WRENCH

(75) Inventor: Jie-Shing Peng, Changhua County (TW)

(73) Assignee: Jie-Shing Peng, Changhua County (TW)

(21) Appl. No.: 12/687,885

(22) Filed: Jan. 15, 2010

(51) Int. Cl. B25B 13/46; F16D 41/12; B21D 28/00

(52) U.S. Cl. 81/63.2; 81/60; 74/575; 72/339

(57) ABSTRACT

A gear unit applies to engaging a ratchet wheel for co-operation, wherein the body material of the gear unit is chose high-density steel through heat processing for enhancing hardness, such as medium carbon steel, high carbon steel, or alloyed steel, and made through continuous multiple cold forging and punching and heat processing; the gear body of the gear unit includes a junction matching the ratchet wheel profile and forming an external tooth through cold forging and punching, and the tooth shape matches the ratchet tooth of the ratchet wheel to engage the ratchet wheel; by way of using the special steel through the process of continuous cold forging and punching and heat processing, the internal structure of the gear unit is dense compaction, so as to improve the mechanical properties, thus the ratchet wheel wrench using the gear unit will have excellent operating performance and long service life.

### BACKGROUND OF THE INVENTION

(a) Field of the Invention

(b) Description of the Prior Art

### SUMMARY OF THE INVENTION

The object of the present invention is to provide a gear unit, molding method of the same and applied ratchet wheel wrench, wherein the material of the gear unit is chose high-density steel through heat processing for enhancing hardness, such as medium carbon steel, high carbon steel, or alloyed steel, and made through continuous multiple cold forging and punching and heat processing, so as to make the internal structure of the unit to be dense compaction, and further to improve the mechanical properties, such as structural intensity, rubbing fastness coefficient, anti-pull intensity, and resist compression intensity, thus the ratchet wheel wrench will have excellent operating performance and long service life.

For achieving the above purpose, the present invention discloses a gear unit applied to engaging a ratchet wheel for co-operation, wherein a ratchet is installed around the ratchet wheel; the gear unit includes a gear body composed of high-density steel, in which the steel is chose from one of a group consisted of medium carbon steel, high carbon steel, and alloyed steel; the gear body is made through multiple cold forging and punching and heat processing, and has a junction matching a part profile of the ratchet wheel; the junction forms an external tooth through cold forging and punching, and the tooth shape matches the ratchet tooth to engage the ratchet of the ratchet wheel.

For a specific embodiment, the steel is chose the steel through heat processing for enhancing hardness.

For a specific embodiment, the alloyed steel is composed of chromoly steel.

The present invention further discloses a ratchet wheel wrench including the gear unit and the ratchet wheel; the ratchet wheel wrench further includes a wrench body installed with a ratchet hole and a holding groove, in which the ratchet hole is used for holding the ratchet wheel; and the holding groove is installed around the ratchet hole for holding the gear unit.

The present invention further discloses a molding method applied to making a ratchet unit, wherein the ratchet unit coordinates with engaging a ratchet wheel for co-operation; and a ratchet is installed around the ratchet wheel; the molding method includes the following steps: first, providing an initial billet, in which the material of the initial billet is high-density steel chose from one of a group consisted of medium carbon steel, high carbon steel, and alloyed steel; next, cutting the initial billet into plural metal plates; then, picking one of such metal plates for cold forging and punching to form a junction matching a part profile of the ratchet wheel; then, cold forging and punching the junction to form an external tooth matching the tooth shape of the ratchet for engaging the ratchet of the ratchet wheel; then, removing the raw edge of the metal plate; and then, performing heat processing on the metal plate; and last, performing surface processing on the metal plate for forming the gear unit.

The above description and the following detailed explanation and drawings are for further explaining the way, means, and effectiveness adopted for achieving the intended purpose, according to the present invention; and the other objects and advantages of the present invention are described in the following explanation and drawings.

### BRIEF DESCRIPTION OF THE DRAWINGS

FIG. 1 is a top view showing the ratchet wheel wrench in prior art;

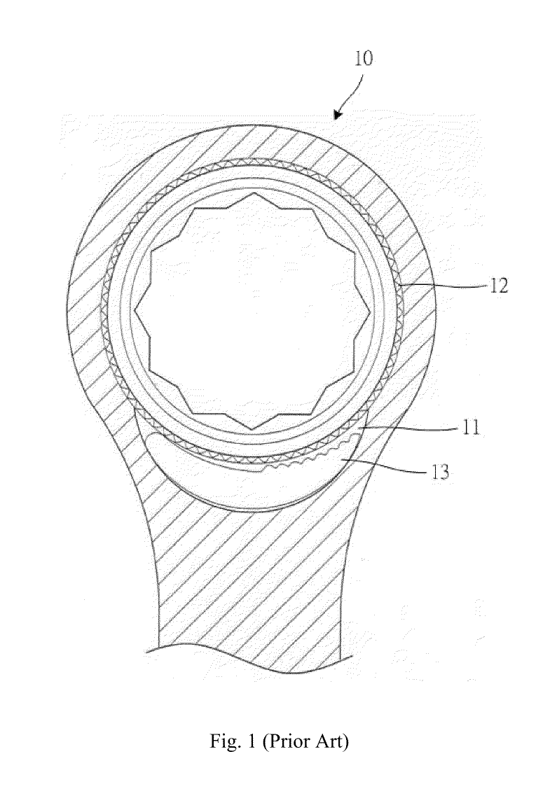

FIG. 2 is a step flowchart showing the molding method of the gear unit in prior art;

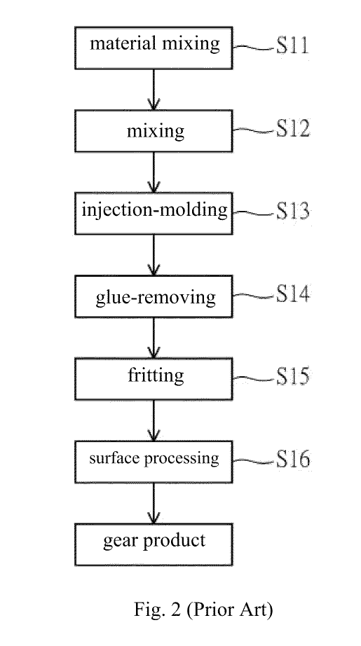

FIG. 3 is a three-dimensional assembly drawing, showing the specific embodiment of the ratchet wheel wrench, according to the present invention;

FIG. 4A, FIG. 4B, FIG. 4C, FIG. 4D, and FIG. 4E are schematic views, showing the molding of the gear unit, according to the present invention;

FIG. 5 is a step flowchart showing the molding method of the gear unit, according to the present invention;

FIG. 6 is a three-dimensional exploded view, showing another embodiment of the ratchet wheel wench, according to the present invention;

FIG. 7 is a combined sectional view of FIG. 6; and

FIG. 8 and FIG. 9 are schematic views, showing the operation of the ratchet wheel wrench, according to the present invention.

### DESCRIPTION OF MAIN COMPONENT SYMBOLS

Ratchet wheel wrench 20
Wrench body 21
Ratchet wheel 30
Gear unit 40
Junction 41
External tooth 42
Gear body 45
Spacing ring 50
Ratchet wheel wrench 60
Wrench body 61
Ratchet hole 62
Spacing ring rib 63
Wedging ring groove 64
Wedging groove slot 65
Holding groove 66
Ratchet wheel 70
Ratchet 71
Detent hole 72
Spacing ring groove 73
Gear unit 80
Junction 81
External tooth 82
Sliding part 83
Junction groove 84
Spring 85
Spacing ring 90
Assembly groove 91
Elastic buckle 95
Initial billet 400
Metal plate 401
Gear body 800

### DETAILED DESCRIPTION OF THE PREFERRED EMBODIMENTS

The present invention provides a gear unit, molding method of the same and applied ratchet wheel wrench, and the main feature is that the material of the gear unit is chose high-density steel through heat processing for enhancing hardness, such as medium carbon steel, high carbon steel, or alloyed steel, and made through continuous multiple cold forging and punching and heat processing, so as to improve the internal structure density, optimize the mechanical property, and make a substantial leap forward in quality than in the past, thus the ratchet wheel wrench has excellent operation performance.

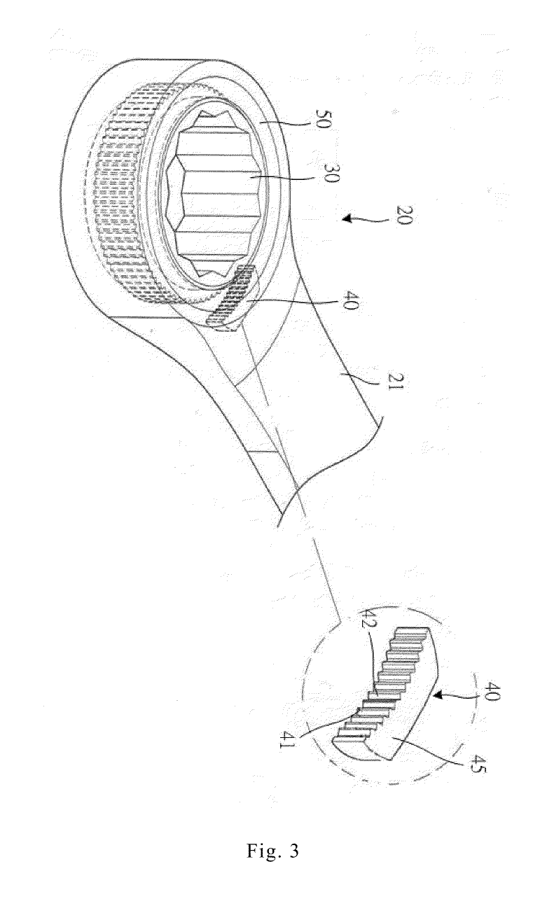

First, referring to FIG. 3, which is a three-dimensional assembly drawing, showing the specific embodiment of the ratchet wheel wrench, according to the present invention; as shown in the figure, ratchet wheel wrench 20 has a wrench body 21, a ratchet wheel 30, and a gear unit 40; the ratchet wheel 30 has cyclic structure, a detent hole is installed inside, and a ratchet is installed on the outer surface; the gear unit 40 is installed within an arc-shaped holding groove of the wrench body 21, and includes a gear body 45 with roughly curved arc structure, and a concave arc junction 41 matching a part profile of the ratchet wheel 30; the junction 41 is installed with an external tooth 42 for mutually embedding with the ratchet of the ratchet wheel 30, so as to make the gear unit 40 to engage the ratchet wheel 30; and the ratchet wheel 30 is assembled at the wrench body 21 through a spacing ring 50 and internal elastic buckle, for together constituting the ratchet wheel wrench 20.

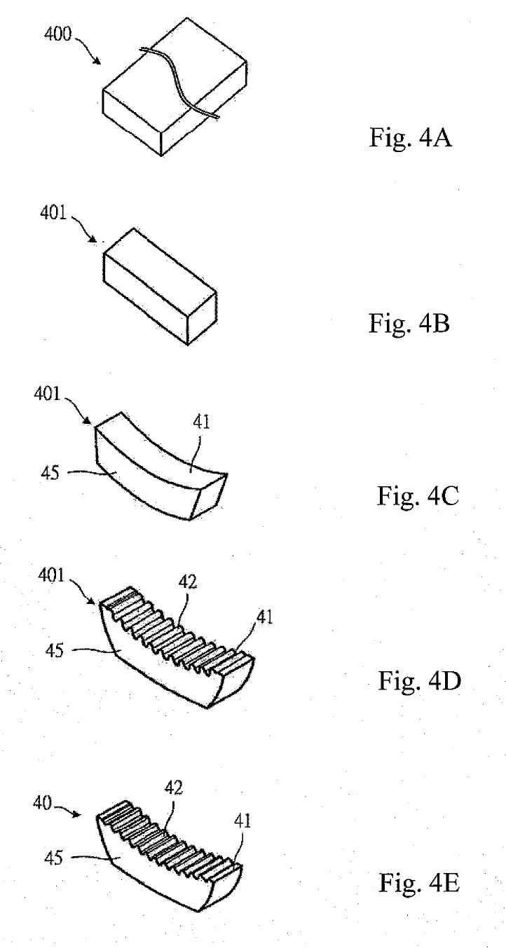

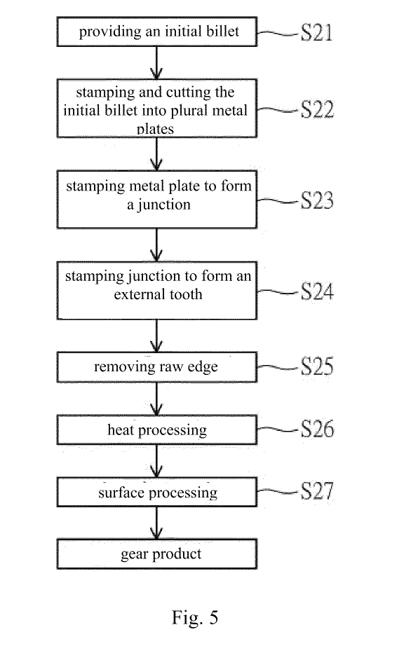

The molding method of the gear unit is described as follow, referring to FIGS. 4A to 4E and FIG. 5; FIGS. 4A to 4E are schematic views, showing the molding of the gear unit, according to the present invention; and FIG. 5 is a step flowchart showing the molding method of the gear unit, according to the present invention; as showing in figures, the molding method includes the following steps:

first, providing an initial billet 400 (as showing in FIG. 4A), in which the material of the initial billet is high-density steel, such as medium carbon steel, high carbon steel, or alloyed steel; the above kinds of steel has excellent structural intensity, and the hardness is further enhanced through follow-up heat processing (Step S21);

next, cutting the initial billet 400 into plural metal plates with defined size through continuously stamping and cutting construction method (Step S22);

then, picking a metal plate 401 (as showing in FIG. 4B) for performing the first cold forging and punching to use the mold to extrude the metal plate 401 from the top and the bottom, and to make the metal plate 401 to be the gear body 45 with basic product structure, in which a junction 41 is formed at one side of the gear body 45 (as showing in FIG. 4C); in this embodiment, the metal plate 401 is changed to be curved arc, and the junction 41 is concave arc for roughly matching a part profile of the ratchet wheel 30 (Step S23);

then, performing the second cold forging and punching, in which the junction 41 of the metal plate 401 forms an external tooth 42 through stamping by the tooth-shaped mold, to make the metal plate 401 to be close to the finished structure (as showing in FIG. 4D), the tooth shape of the external tooth 42 coordinates with the ratchet tooth of the ratchet wheel 30, and the cold forging and punching process is repeatedly performed to make the external tooth 42 to be complete structure (Step S24);

then, performing the third cold forging and punching, to remove the remaining raw edge produced by continuous stamping, and to make the whole structure more dense compaction, in which the metal plate 401 becomes the gear body 45 with the exterior structure of the final gear (as showing in FIG. 4E) to be the semi-finished product (Step S25);

then, performing heat processing on the semi-finished product of the gear, to eliminate the internal remaining shear stress, and to increase the hardness, anti-pull intensity, and resist compression intensity of the semi-finished product (Step S26); and

last, performing surface processing on the semi-finished product of the gear, for which the heat processing is complete, such as sandblasting and anti-rust, in which the finished product of the gear unit 40 is formed after the step is complete (Step S27).

For a preferred embodiment, chromoly steel metal plate is used to be the initial billet 400 in Step S21. The hardness of the chromoly steel is further dramatically enhanced after the heat processing in S26. Furthermore, because the cold forging and punching makes small shaping change, the organization of metal crystal particles within the metal plate 401 is gradually and slowly produced local flow and distortion, so as to effectively keep the consecutive, uniform and streamline natures of the structural organization, and to achieve homogenization and fine particles to be dense compaction. The gear unit 40 made by the molding method can prevent damaged structural organization and hardening produced by dramatically shaping change or over-forging, and hold well mechanical properties, such as high density, high structural intensity, high rubbing fastness coefficient, and excellent anti-pull intensity and resist compression intensity, thus the ratchet wheel wrench 20 will have excellent operating performance and long service life.

The inventor makes three gear units according to the above molding method to test and verify the feasibility of the present invention, in which each gear unit is installed at the ratchet wheel wrench to perform torque test through torque test machine with maximum torque value set at 5493 kg-cm, the test data is shown as table 1, and the samples 1, 2, and 3 represent the three ratchet wheel wrenches applied to the present invention.

TABLE 1

| Sample Number | 1 | 2 | 3 |
|---|---|---|---|
| maximum torque value (kg-cm) | 4697.32 | 4802.94 | 4542.76 |

The maximum torque value of the ratchet wheel wrench equipped with the conventional 19MM gear unit made by powder metallurgy is 3226 Kg-cm, the present invention indeed elevates the mechanical feature of the ratchet wheel wrench to unprecedented high level through the data in the above table. The gear unit is an important component of the ratchet wheel wrench and the key factor of the performance, the present invention improves the manufacturing quality and the mechanical feature, thus the performance and the service life of the ratchet wheel wrench is together improved.

What needs to be stressed is that, the above molding method of the gear unit applies to the gear unit with any exterior structure. Except for the curved arc shape in the embodiment, the exterior shape coordinating with the design of the ratchet wheel wrench can be strip, rectangular, triangular, ladder-shaped, and any other irregular shape.

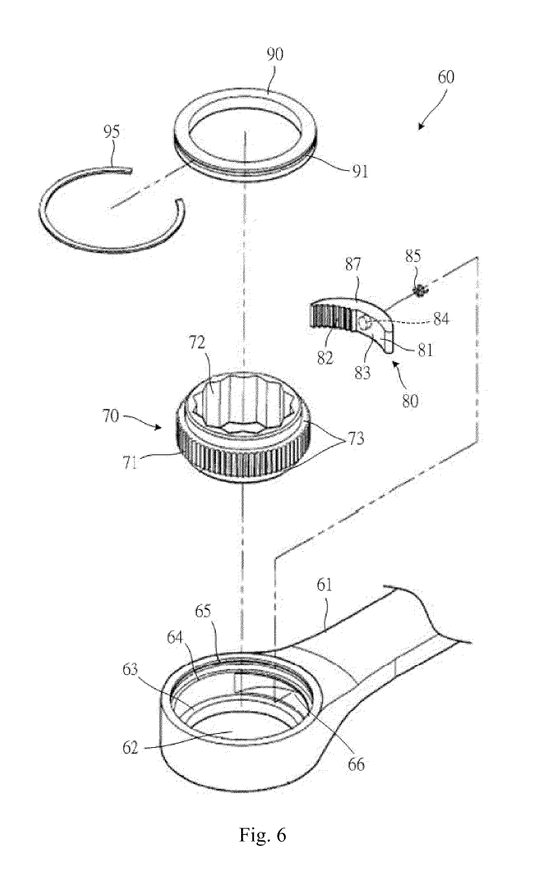

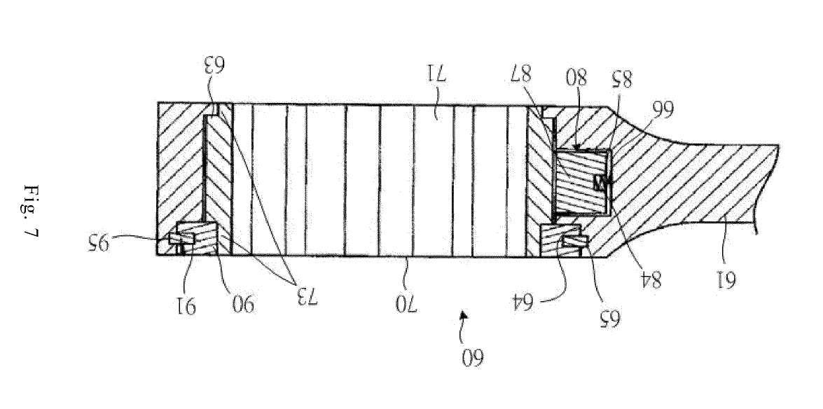

Then, the internal component structure of the ratchet wheel wrench is further described through another embodiment of the gear unit. Referring to FIG. 6 and FIG. 7, which are respectively three-dimensional exploded view and combined sectional view of another embodiment of the ratchet wheel wench of the present invention, in which the ratchet wheel wrench 60 is constituted by a wrench body 61, a ratchet wheel 70, a gear unit 80, a spacing ring 90, and an elastic buckle 95.

One end of the wench body 61 is installed with a through ratchet hole 62, and another end is made to be a grip. A spacing ring rib 63 is installed around one end of the ratchet hole 62, a wedging ring groove 64 is installed around another end, and a wedging groove slot 65 is installed around within the wedging ring groove 64. In the wrench body 61, an arc-shaped holding groove 66 is buried at the position where the ratchet hole 62 is adjacent to the grip.

For the ratchet wheel 70, a ratchet 71 is installed around outside, a detent hole 72 is installed inside, and the top and the bottom are installed with a spacing ring groove 73, respectively. The detent hole 72 is used for fitting locking components including screws and nuts, the spacing ring groove 73 is used for assisting the ratchet wheel 70 to combine with the ratchet hole 62, and an assembly groove 91 is installed around outside of the spacing ring 90.

The gear unit 80 has a gear body 800, whose material is chose high-density steel through heat processing for enhancing hardness, such as medium carbon steel, high carbon steel, or alloyed steel, adopting cold forging and punching to form exterior structure, and then to be final product through heat processing and surface processing. The structure of the gear body 800 is roughly curved arc-shaped, and has a concave arc junction 81 roughly matching the exterior of the ratchet wheel 70, so as to fit a part profile of the ratchet wheel 70. The opposite surface of the junction 81 is convex arc. A region of the junction 81 is installed with an external tooth 82, whose tooth shape coordinating with that of the ratchet 71, thus the gear unit 80 engages the ratchet wheel 70; the region adjacent to the external tooth 82 is installed with a lower and smooth sliding part 83. A junction groove 84 is installed at the gear unit 80 relative to the convex arc surface of the junction 81, where is the corresponding region of the sliding part 83.

The ratchet wheel wrench 60 further has a spring 85 put into the junction groove 84 when assembling, to be held together with the gear unit 80 within the holding groove 66, thus the gear unit 80 accepts the outward elastic force of the spring 85. The ratchet wheel 70 is assembled within the ratchet hole 62 of the wench body 61, with the spacing by the spacing ring groove 73 coordinating with the spacing ring rib 63. The elastic buckle 95 first buckles into the assembly groove 91, and is positioned together with the spacing ring 90 at the wedging ring groove 64, also through the elastic buckle 95 buckling into the wedging groove slot 65, for assisting the spacing ring 90 assembled at the wrench body 61. The two ends of the ratchet wheel 70 respectively have the spacing by the spacing ring rib 63 and the spacing ring 90, and the ratchet hole 62 can rotate in the ratchet hole 62.

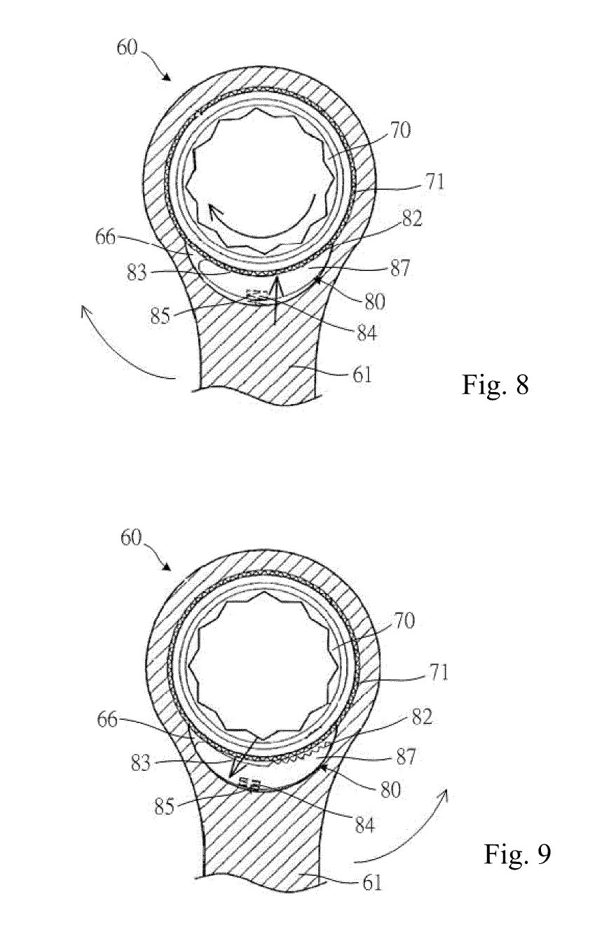

Referring to FIG. 8 and FIG. 9, which are schematic views showing the operation of the ratchet wheel wrench, according to the present invention. FIG. 8 shows the force applied for wrenching, if the wrench body 61 rotates clockwise, the force of the ratchet wheel 70 counterclockwise applies against the gear unit 80, and indirectly against the fitted screw or nut, to twist tight or disassemble the components. When the wrench body 61 rotates clockwise, the gear unit 80 is pushed toward tilted direction by the elastic force of the spring 85, to make the external tooth 82 and the ratchet 71 of the ratchet wheel 70 to engage each other, and the sliding part 83 provides the function of keeping out of the way. Thus, when the wrench body 61 rotates, the ratchet wheel 70 is led to rotate to produce the force applied against the locked components and wrenching the fitted components

FIG. 9 shows the spinning and wrenching situation; when the wrench body 61 rotates counterclockwise, the force of the ratchet wheel 70 clockwise applies against the gear unit 80, the gear unit 80 is pushed by the spring 85, but the pushing force and the direction are contrary and on the same straight line, the external tooth 82 of the gear unit 80 cannot successfully engage the ratchet 71 of the ratchet wheel 70, and is pushed toward the inside of the arc holding groove 66 by the ratchet 71. The ratchet 71 slides along the sliding part 83 with intermittent “kou-kou” sound for spinning. By way of the mechanism, the ratchet wheel wrench 70 can restore the position for repeating the wrenching operations without disconnecting the fitted mechanical components.

From the above, in the gear unit, molding method of the same and applied ratchet wheel wrench of the present invention, the material of the gear unit is chose high-density steel through heat processing for enhancing hardness, such as medium carbon steel, high carbon steel, or alloyed steel, and multiple cold forging and punching and heat processing are continuously performed to form the exterior of the gear, thus the internal organization of the product will be dense compaction, and the mechanical features are improved, such as the whole structural intensity, rubbing fastness coefficient, anti-pull intensity, and resist compression intensity, to avoid damage because of long-term or improper use, and to improve the operating performance and long service life of the ratchet wheel wrench. In summary, the present invention indeed has the uniqueness, and the unobviousness and usefulness for the industry, and is applied for patent application as related regulations; the inventor earnestly requests your reviewer for awarding legal patent rights.

The above descriptions and drawings is only for the specific embodiments of the present invention, but not for any limitation; the scope of the present invention is based on the following claims, and it is obvious to the skilled in the art to conceive that the variations and modifications of the embodiments fall in the scope of the present invention.

What is claimed is:

1. A gear unit applied to engaging a ratchet wheel for co-operation, wherein a ratchet is installed around the ratchet wheel; the gear unit includes:
a gear body composed of high-density steel, in which the steel is chose from one of a group consisted of medium carbon steel, high carbon steel, and alloyed steel; the gear body is made through multiple cold forging and punching and heat processing, and has a junction matching a part profile of the ratchet wheel; the junction forms an external tooth through cold forging and punching, and the tooth shape matches the ratchet tooth to engage the ratchet of the ratchet wheel.

2. The gear unit as claimed in claim 1, wherein the steel is chose the steel through heat processing for enhancing hardness.

3. The gear unit as claimed in claim 1, wherein the alloyed steel is chromoly steel.

4. A ratchet wheel wrench, including the gear unit and the ratchet wheel as claimed in claim 1, wherein the ratchet wheel wrench further includes:
a wrench body installed with a ratchet hole and a holding groove, in which the ratchet hole is used for holding the ratchet wheel; and the holding groove is installed around the ratchet hole for holding the gear unit.

5. A ratchet wheel wrench, including the gear unit and the ratchet wheel as claimed in claim 2, wherein the ratchet wheel wrench further includes:
a wrench body installed with a ratchet hole and a holding groove, in which the ratchet hole is used for holding the ratchet wheel; and the holding groove is installed around the ratchet hole for holding the gear unit.

6. A ratchet wheel wrench, including the gear unit and the ratchet wheel as claimed in claim 3, wherein the ratchet wheel wrench further includes:
a wrench body installed with a ratchet hole and a holding groove, in which the ratchet hole is used for holding the ratchet wheel; and the holding groove is installed around the ratchet hole for holding the gear unit.

7. The ratchet wheel wrench as claimed in claim 4, wherein the gear unit further includes a junction groove installed on the opposite surface of the junction of the gear body; and the ratchet wheel wrench further includes a spring held in the junction groove of the gear body for two-way junction with the wrench body and the gear unit.

8. The ratchet wheel wrench as claimed in claim 5, wherein the gear unit further includes a junction groove installed on the opposite surface of the junction of the gear body; and the ratchet wheel wrench further includes a spring held in the junction groove of the gear body for two-way junction with the wrench body and the gear unit.

9. The ratchet wheel wrench as claimed in claim 6, wherein the gear unit further includes a junction groove installed on the opposite surface of the junction of the gear body; and the ratchet wheel wrench further includes a spring held in the junction groove of the gear body for two-way junction with the wrench body and the gear unit.

10. The ratchet wheel wrench as claimed in claim 4, wherein the gear body further includes a sliding part installed on the junction adjacent to the region of the external tooth.

11. The ratchet wheel wrench as claimed in claim 5, wherein the gear body further includes a sliding part installed on the junction adjacent to the region of the external tooth.

12. The ratchet wheel wrench as claimed in claim 6, wherein the gear body further includes a sliding part installed on the junction adjacent to the region of the external tooth.

13. The ratchet wheel wrench as claimed in claim 10, wherein the gear unit further includes a junction groove installed on the opposite surface of the opposite surface of the junction of the gear body, and corresponding to the region of the sliding part; and the ratchet wheel wrench further includes a spring held in the junction groove of the gear unit for two-way junction with the wrench body and the gear unit.

14. The ratchet wheel wrench as claimed in claim 11, wherein the gear unit further includes a junction groove installed on the opposite surface of the opposite surface of the junction of the gear body, and corresponding to the region of the sliding part; and the ratchet wheel wrench further includes a spring held in the junction groove of the gear unit for two-way junction with the wrench body and the gear unit.

15. The ratchet wheel wrench as claimed in claim 12, wherein the gear unit further includes a junction groove installed on the opposite surface of the opposite surface of the junction of the gear body, and corresponding to the region of the sliding part; and the ratchet wheel wrench further includes a spring held in the junction groove of the gear unit for two-way junction with the wrench body and the gear unit.

16. A molding method applied to making a ratchet unit, wherein the ratchet unit coordinates with engaging a ratchet wheel for co-operation; and a ratchet is installed around the ratchet wheel; the molding method including the following steps:
providing an initial billet, in which the material of the initial billet is high-density steel chose from one of a group consisted of medium carbon steel, high carbon steel, and alloyed steel;
cutting the initial billet into plural metal plates;
picking one of such metal plates for cold forging and punching to form a junction matching a part profile of the ratchet wheel;
cold forging and punching the junction to form an external tooth matching the tooth shape of the ratchet for engaging the ratchet of the ratchet wheel;
removing the raw edge of the metal plate;
performing heat processing on the metal plate; and
performing surface processing on the metal plate for forming the gear unit.

17. The molding method as claimed in claim 16, wherein the material of the initial billet is chose the steel through heat processing for enhancing hardness.

18. The molding method as claimed in claim 16, wherein the alloyed steel is chromoly steel.
